(19) United States
(12) Patent Application Publication
(10) Pub. No.: US 2009/0231751 A1
(43) Pub. Date: Sep. 17, 2009

(54) METHOD AND APPARATUS FOR SERVO CONTROL ASSOCIATED WITH ROTATIONAL SPEED OF DISK IN DISK DRIVE

(75) Inventors: Makoto Asakura, Tokyo (JP); Yuji Sakai, Ome-shi (JP); Shuuichi Kojima, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/391,047

(22) Filed: Feb. 23, 2009

(30) Foreign Application Priority Data
Mar. 12, 2008 (JP) 2008-062939

(51) Int. Cl. G11B 15/46

(52) U.S. Cl. 360/73.01; G9B/15.054

(57) ABSTRACT

According to one embodiment, a disk drive is disclosed to which a plurality of disk rotational speed modes can be set. The disk drive is configured such that input of servo data from servo sectors is thinned out by thinning out an output of an interrupt request to a CPU in a high-speed rotation mode. At the time, a disk controller obtains servo data reproduced from all the servo sectors at timing of servo gates and stores it to a register.

### CROSS-REFERENCE TO RELATED APPLICATIONS

This application is based upon and claims the benefit of priority from Japanese Patent Application No. 2008-062939, filed Mar. 12, 2008, the entire contents of which are incorporated herein by reference.

### BACKGROUND

1. Field

One embodiment of the present invention relates to a disk drive having a function for changing disk rotational speed, and more particularly to a servo control technique when a disk rotates at high speed.

2. Description of the Related Art

Recently, in a disk drive representing a hard disk drive, there is proposed a disk drive having a function for changing the rate of rotation of a disk (refer to, for example, Jpn. Pat. Appln. KOKAI Publication No. 2006-294092).

The disk drive is configured to rotate a disk at high speed when data is recorded and at low speed when data is reproduced. With this operation, a time necessary to record data can be reduced and power consumption can be saved when data is reproduced.

In this case, when the disk rotates at low speed, a servo control is executed using the short servo wedge format mode. In this mode, the servo pattern is formatted same short servo data portions between normal full servo data portions. In contrast, when the disk rotates at high speed, a servo control is executed using the normal servo wedge mode, to thin out reproduction of the short servo data portion.

Further, there is also proposed a disk drive for executing a servo process for thinning out servo gates when a read/write access is not performed although the rate of rotation of a disk is fixed, (refer to, for example, Japanese Patent No. 2650720).

The disk drive which changes the rate of rotation of a disk can reduce time when data is recorded and can reduce power consumption when data is reproduced. Further, the performance of the disk drive can be improved by reducing an occupying rate a servo control process of a microprocessor (CPU) by a servo control for thinning out the reproduction of servo data when a disk rotates at high speed. However, in the method of simply thinning out the reproduction of the servo data, when the disk rotates at high speed, a positioning accuracy of a head is degraded as well as it is difficult to secure sufficient positioning accuracy when necessary. Since disturbance also increases when the disk rotates at high speed, it is difficult to secure sufficient positioning accuracy. Further, in the method of thinning out the servo gates, it is difficult to realize a stable read/write operation because a configuration for managing the gates for the read/write operation is made complex.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a main portion of a disk drive according to embodiments of the present invention;

FIGS. 2A and 2B are timing charts explaining a basic servo control operation;

FIGS. 3A and 3B are timing charts explaining a servo control operation according to a first embodiment;

FIGS. 4A and 4B are timing charts explaining a servo control operation according to a second embodiment;

FIG. 5 is a flowchart explaining a basic servo control operation;

FIG. 6 is a flowchart explaining the servo control operation according to the first embodiment; and

FIG. 7 is a flowchart explaining the servo control operation according to the second embodiment.

### DETAILED DESCRIPTION

Various embodiments according to the invention will be described hereinafter with reference to the accompanying drawings. In general, according to one embodiment of the invention, there is provided a disk drive can reduce an occupying rate of a servo control process when a disk rotates at high speed and can secure sufficient head positioning accuracy when necessary in a disk drive having a function for changing the disk rotational speed.

### First Embodiment

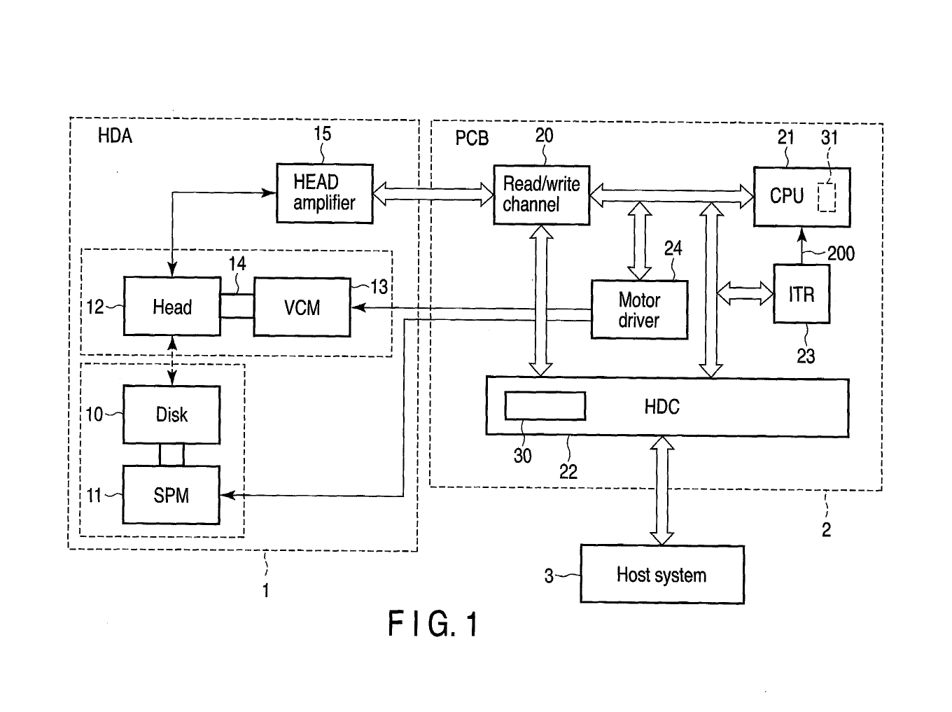

According to an embodiment, FIG. 1 shows a block diagram showing a main portion of a disk drive.

The disk drive is roughly composed of a head disk assembly (HDA) 1 and a printed circuit board (PCB) 2. The HDA 1 has a disk 10 rotated by a spindle motor (SPM) 11, a head 12 mounted on an actuator 14, and a head amplifier 15.

The SPM 11 is controlled by a microprocessor 21 (CPU) through a motor driver 24 as described below. The SPM 11 rotates the disk 10 at high speed or low speed. The actuator 14 is driven rotationally by a voice coil motor (VCM) 13 and moves the head 12 in a radial direction of the disk 10. The head 12 is mounted on a slider with a read element and a write element separated from each other and writes (records) or reads (reproduces) data to or from the disk 10. The head amplifier 15 amplifies a read signal (reproduction signal) outputs from the read element of the head 12 and transmits it to a read/write channel (R/W channel) 20. Further, the head amplifier 15 supplies a write current according to a write signal outputs from the read/write channel 20 to the write element of the head 12.

The PCB 2 has the read/write channel 20, the CPU 21, a hard disk controller (HDC) 22, an interrupt controller (ITR) 23, and the motor driver 24 mounted thereon. Note that the respective circuits 20 to 23 other than the motor driver 24 may be integrated as a one chip LSI.

The motor driver 24 outputs a current for controlling drive of the SPM 11 and the VCM 13 under the control of the CPU 21. The read/write channel 20 is a signal processing unit for executing a signal process necessary to record and reproduce servo data and user data. As described later, the read/write channel 20 reproduces the servo data read from the head 12 and outputs it to the HDC 22.

The HDC 22 is an interface between the disk drive and a host system 3 and controls transfer of write data and read data. The HDC 22 has a register 30 for storing the servo data reproduced by the read/write channel 20. Further, the HDC 22 transmits data and a command between it and the CPU 21 and requests a servo interrupt through the interrupt controller 23. The host system 3 is a personal computer and digital equipment.

The CPU 21 is a main controller of the disk drive and executes a control process for switching the rotational speed of the disk 10 and a servo control process for positioning the head 12 at a target position on the disk 10. The CPU 21 has a memory 31 for storing information showing high-speed rotation mode and low-speed rotation mode for controlling the rotational speed of the disk 10 and servo data read from the register 30 of the HDC 22.

(Servo Control Operation)

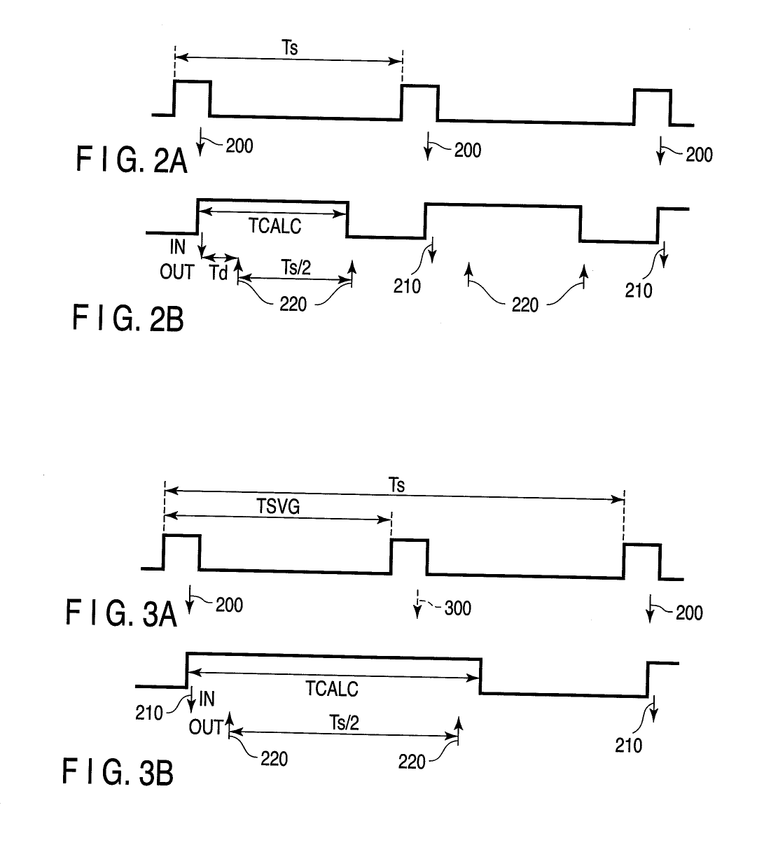

A servo control operation of the embodiment will be explained below referring to FIGS. 2A to 4B and FIGS. 5 and 6.

First, a basic servo control operation of the disk drive will be explained referring to timing charts of FIGS. 2A and 2B and a flowchart of FIG. 5.

In the disk drive, a plurality of servo sectors are disposed on the disk 10 in a circumferential direction at predetermined intervals. The respective servo sectors are disposed approximately radially. Servo data is recorded to the servo sectors to position the head 12 at a target position (target track position) on the disk 10. The servo data includes address information and a servo burst signal. The address information includes a track address for identifying a lot of tracks disposed concentrically and a sector address for identifying the respective servo sectors. The servo burst signal is a position error signal (PES) for creating position information for detecting a head position in the range of each track.

The head 12 reads the servo data from the servo sectors of the rotating disk 10. The head amplifier 15 outputs the servo data read by the head 12 to the read/write channel 20. The read/write channel 20 reproduces the servo data and outputs it to the HDC 22. The HDC 22 stores the reproduced servo data to the register 30.

The CPU 21 reads the servo data from the register 30 of the HDC 22, calculates the position information (servo information including address information) of the head 12, and creates a control output value (VCM command) for controlling drive of the VCM 13 of the actuator 14. The CPU 21 controls drive of the actuator 14 by outputting the created control output value to the motor driver 24 to thereby control a position of the head 12.

The servo control operation corresponds to a servo process of a discrete-time system because the servo data is obtained only at a time at which the head 12 passes through the servo sectors. In this case, a servo cycle is determined at time intervals at which the servo sectors pass just below the head 12.

Further, the number of servo sectors when the disk 10 rotates once is designed to obtain a necessary positioning accuracy of the head 12. When the disk 10 is rotated by the SPM 11 at a predetermined rate of rotation, a control frequency Fs is calculated from an expression of “Fs=Fr×Ss”, where Fr shows the rotational frequency of a disk, and Ss shows the number of servo sectors.

In the disk drive of the embodiment, the HDC 22 outputs a request to the read/write channel 20 to detect the servo data at a timing at which the servo sectors of the rotating disk 10 pass just below the head 12. That is, as shown in FIG. 2A, the HDC 22 outputs servo gates having a cycle Ts to the read/write channel 20.

The read/write channel 20 processes and reproduces the servo data (including the address information and the position error signal) read from the servo sectors by the head 12. As shown in FIG. 5, the HDC 22 obtains the servo data reproduced by the read/write channel 20 and stores it to the register 30 (block 500).

As shown in FIG. 2B, the HDC 22 issues a servo interrupt request 200 to the CPU 21 through the interrupt controller 23 in association with the request for detection to the read/write channel 20. On receiving the interrupt request, the CPU 21 boots up a servo interrupt processing routine and starts a series of servo control processes.

That is, the CPU 21 reads the servo data from the register 30 of the HDC 22, creates servo information, and stores it to the memory 31. The CPU 21 calculates a present head position on the disk 10 and obtains the position information thereof (block 501). The CPU 21 calculates deviation information between a request position (target position) at which the head 12 is to be positioned and a present head position and executes a first control process calculation to position the head 12 to the request position based on the deviation information (block 502).

The CPU 21 calculates a control output value (VCM output value or VCM output command value) for controlling drive of the actuator 14 by the first control process calculation and sets it to a control output register of the HDC 22 (block 503). After the VCM output value is set, the CPU 21 executes a second control process calculation as a second servo control process based on the deviation information (block 504). Note that a time T_{CALC} shown in FIG. 2B shows the total of first and second control process calculation times of the CPU 21.

The HDC 22 executes a control such that a current, which corresponds to the VCM output value set to the control output register, is supplied to the VCM 13 through the motor driver 24 at appropriate timing. The series of servo control processes is repeatedly executed at each control cycle Ts to thereby realize a proper positioning operation of the head 12.

As shown in FIG. 2B, the disk drive employs a multirate output 220 for setting a plurality of VCM output values between the sample points (servo gates) of the servo data. That is, the CPU 21 creates the plurality of VCM output values (which are two output values here) by the first control process calculation and sets it to the output register of the HDC 22. At the time, the CPU 21 also sets a timing counter value and the like for transmitting a second VCM output to the motor driver 24. When the timing counter value becomes zero, the HDC 22 transmits the second VCM output value to the motor driver 24 and switches the exciting current of the VCM 13.

As shown in FIG. 2B, the time Td from timing 210 at which the CPU 21 inputs the servo data to the first VCM output 220 is called an input/output delay time, by which the limit of stability of a servo control system is greatly affected. A shorter input/output delay time Td permits a servo control design to be made more easily.

The CPU 21 executes only the servo control process which cannot be calculated unless the servo data obtained by the first control process calculation is used. Further, to prepare for a next servo control calculation by the second control process calculation, the CPU 21 executes calculation of the portions of a necessary servo control calculation which can be previously executed and stores a result of the calculation to the memory 31. Specifically, the CPU 21 calculates a feedforward control amount such as compensation and the like of a repeatable runout (RRO), which is in synchronization with, for example, the rotation of the SPM 11, by the second control process calculation.

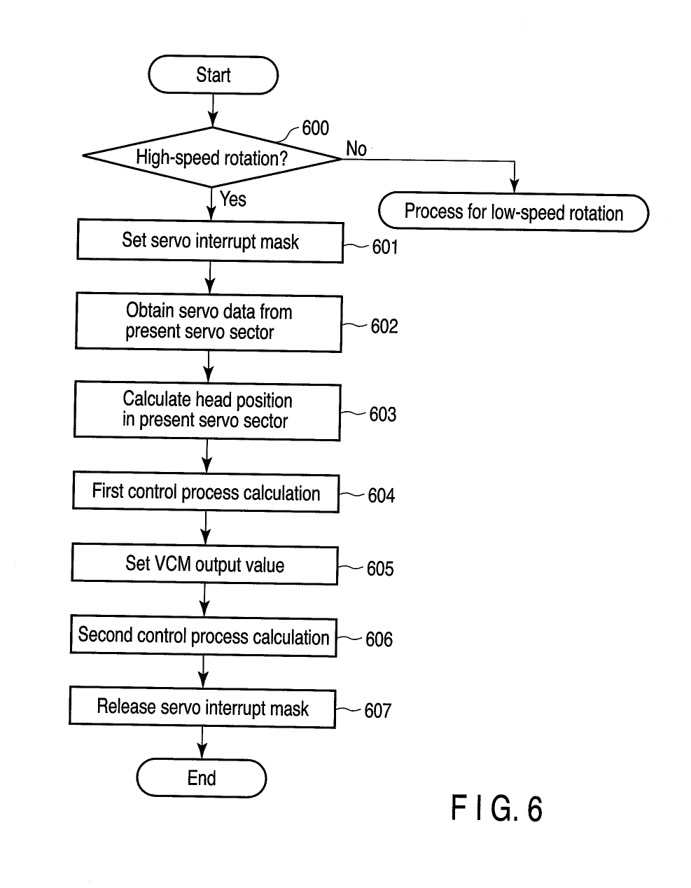

Next, a feature of the servo control operation of the embodiment will be explained referring to timing charts of FIGS. 3A and 3B and a flowchart of FIG. 6.

First, the disk drive of the embodiment has a function for changing the rotational speed (rate of rotation) of the disk 10. That is, the CPU 21 holds information (flag) for switching between the high-speed rotation mode and the low-speed rotation mode in the memory 31 and controls the rotational speed of the SPM 11 to a high rotational speed or a low rotational speed through the motor driver 24 according to the information.

Specifically, in a low power consumption mode for saving power consumption, the CPU 21 controls the rotational speed of the SPM 11 so that the rotational speed of the disk 10 is reduced. In contrast, when performance is enhanced to increase data transfer speed, and the like, the CPU 21 controls the rotational speed of the SPM 11 so that the rotational speed of the disk 10 is increased. In this case, the high-speed rotation of the disk 10 includes a standard rotational speed which is relatively higher than the low-speed rotation.

In the disk drive, in which disk rotational speed can be changed as described above, servo control frequency increases in proportion to the rotational speed when the disk rotates at high speed in the servo control frequency Fs by which drive performance can be secured at low-speed rotation. In particular, there is a high possibility that a problem arises in that the servo control calculation time (approximately constant value T_{CALC}) of the CPU 21 is not within the servo control cycle thereof and the CPU 21 does not operate normally. That is, when the disk 10 rotates at high speed, since “T_{CALC}>Tₛ” is established, the CPU 21 does not operate normally. In contrast, when the maximum number of servo sectors, which is within the servo control calculation time of the CPU 21 in high-speed rotational mode, is determined, since the servo control frequency is very greatly reduced in low-speed rotational mode, it is difficult to devise a control design that guarantees sufficient drive performance.

To cope with the above problem, in the embodiment, when the disk 10 rotates at high speed, the CPU 21 executes a servo control process for thinning out the input of the servo information. The servo control process will be specifically explained below.

First, as a specification of the disk drive of the embodiment, the high rotational speed of the disk 10 is twice the low rotational speed. A minimum number of servo sectors, which can secure a necessary head positioning accuracy in low-speed rotation, are disposed on the disk 10. The HDA 1 is provided with a dynamic floating height (DFH) control function so that an optimum floating height of the head 12 can be secured in each of two rotational speeds, that is, the high rotational speed and the low rotational speed.

Further, the timing 210 at which the CPU 21 inputs the servo data to the timing at which the CPU 21 outputs a first VCM is the same as the timing (input/output delay time Td) shown in FIG. 2B. The CPU 21 has a predetermined operation clock in either high-speed rotation mode or low-speed rotation mode.

Next, a processing procedure, which is executed to switch the disk drive of the embodiment to high-speed rotation mode, will be explained.

In the disk drive, when a request for switching to high-speed rotation mode is issued from the host system 3, the CPU 21 retracts once the head 12 on the disk 10 outside of the disk 10 and sets a flag for high-speed rotation mode in the memory 31. With this operation, the CPU 21 switches access destinations of control parameters and the like to high-speed rotation mode. Further, since a passing-through frequency of the servo sectors also increases in proportion to the rotational speed, setting and the like of a clock frequency (F_{SFG}) for detecting the servo data in the read/write channel 20 is also switched. Since the clock is switched, the gate timing of the servo gates and the like is generated at approximately the same passing-through timing to the disk 10.

Further, the CPU 21 executes a process for changing the rotational speed of the SPM 11 to the high rotational speed. After the rotation of the SPM 11 is adjusted and fixed, the CPU 21 moves the head 12 to a track position on the disk 10 before it is retracted and executes a positioning control. The CPU 21 controls the head 12 so that the slider thereof is set to an optimum floating height in high-speed rotation mode by the dynamic floating height (DFH) control function described above.

Next, a specific procedure of the servo control process executed by the CPU 21 will be explained referring to thereof flowchart of FIG. 6.

When a servo interrupt is issued from the interrupt controller 23, the CPU 21 confirms whether or not the flag for high-speed rotation mode is set to the memory 31 (block 600). The CPU 21 executes an ordinary servo control process in low-speed rotation mode (block 600: NO).

The CPU 21 executes a servo interrupt mask process in high-speed rotation mode (block 601). Specifically, the CPU 21 changes setting of an interrupt mask register of the interrupt controller 23, which outputs the servo interrupt request to the CPU 21, according to the control of the HDC 22. That is, the CPU 21 prevents the servo interrupt request from being output to the CPU 21 when the head 12 passes through the servo sectors on the disk 10. With this process, it can be prevented that a next servo interrupt request is issued while the servo control process is being executed by the CPU 21.

As shown in FIG. 3A, the HDC 22 outputs servo gates of a frequency T_{svg} to the read/write channel 20 at the timing at which the servo sectors of the rotating disk 10 pass just below the head 12. The HDC 22 obtains the servo data reproduced by the read/write channel 20 according to the timing of the servo gates and stores it to the register 30 (block 602).

As shown in FIG. 3B, the HDC 22 issues the servo interrupt request 200 to the CPU 21 through the interrupt controller 23. At the time, the interrupt controller 23 does not output a servo interrupt request 300 to the CPU 21 according to the timing of a next servo gate in response to setting of the interrupt mask register.

The CPU 21 reads the servo data from the register 30 of the HDC 22 in response to the interrupt request 200 and stores it to the memory 31. The CPU 21 calculates the position information (servo information) for determining a present head position on the disk 10 using the servo data (block 603).

Thereafter, the CPU 21 executes the first control process calculation for positioning the head 12 to the request position as described above (block 604). Further, the CPU 21 calculates the VCM output value and sets it to the control outputs register of the HDC 22 (block 605). After the VCM output value is set, the CPU 21 executes the second control process calculation described above at a second time (block 606). That is, as shown in FIG. 3B, the CPU 21 starts the servo control process after it receives the interrupt request 200 and finishes it after calculation time T_{CALC} passes.

The CPU 21 releases the servo interrupt mask set by the interrupt mask register of the interrupt controller 23 and returns it to an original state just before the CPU 21 finishes the servo control process (block 607). With this operation, when the head 12 passes through the servo sectors on the disk 10, the servo interrupt request 200 is issued again. Note that the servo interrupt mask need not be necessarily released just before the servo control process is finished and may be released at any time before an arbitrary period of time passes from the finish of the servo control process.

As described above, in the embodiment, when the rotation of the disk 10 is set to high-speed rotation mode, the CPU 21 executes the servo control process by which the servo interrupt mask is set and released. As shown in FIG. 3A, as the disk 10 rotates at high speed, the cycle of intervals T_{SVG} of the servo gates is reduced to about half in terms of the rate of rotation. In contrast, since the operation clock of the CPU 21 is fixed, the calculation time T_{CALC} of the servo control process does not almost change. In the embodiment, since the servo interrupt mask is set, no servo interrupt request 300 is issued while the servo control process is being executed as shown in FIG. 3B. Accordingly, since a state, in which odd or even servo sectors are thinned out, appears, it is possible to realize the servo control process having a stable control cycle “Tₛ=2×T_{SVG}” in high-speed rotation mode. That is, a positioning control of the head 12 which is necessary to the disk drive can be realized in high-speed rotation mode.

Note that in the embodiment, since the timing of the second VCM command output 220 described above is also switched and set as one of the control parameters when the rotation mode is switched to high-speed rotation mode, an appropriate time interval (Ts/2) can be secured. In short, in high-speed rotation mode in which the disk 10 is rotated at high speed, a servo operation state (Tₛ>T_{CALC}), in which sufficient servo control process time is secured, is realized by increasing the control cycle by thinning out the servo sectors. With this operation, a stable servo control, that is, a stable positioning control of the head 12 can be executed in the state that the operation clock of the CPU 21 is fixed. This is also advantageous in that the control design can be easily made because the change of the control frequency can be suppressed in the servo control.

Further, in the embodiment, the HDC 22 creates the servo gates without thinning out them in high-speed rotation mode as shown in FIG. 3A. Accordingly, the HDC 22 obtains the servo information of all the servo sectors on the disk 10 from the read/write channel 20 and stores it to the register 30. Therefore, although the CPU 21 thins out the servo data of the servo sectors corresponding to a not issued servo interrupt request 300, the HDC 22 stores the servo data of all the servo sectors. With this operation, in the disk drive having the two operation modes, that is, low-speed rotation mode and high-speed rotation mode, a design as to the generation of the servo gates can be easily executed in the HDC 22.

Note that the embodiment employs such a system that the CPU 21 obtains the servo data and a process for converting the servo data into the position information is executed by software. However, the embodiment is not limited to the method and may employ a method in which a hardware calculation circuit of a servo is provided on the HDC 22 side and the CPU 21 reads the position information which is a result obtained by the process executed by the hardware calculation circuit from the register of the HDC 22. In this case, a process of the block 603 shown in the flowchart of FIG. 6 can be omitted.

Further, in the embodiment, although the CPU 21 executes the servo interrupt mask process when the servo interrupt starts, it may execute the process just after the VCM output 220 is set to thereby reduce the input/output delay time Td.

Further, in the embodiment, the time interval/gap (Ts/2) is set as the timing of the second VCM command output 220. This is only an example, and the time interval may be arbitrarily set because it is one of control design parameters.

According to the embodiment, the servo control can be realized which does not require a special configuration for managing the gates for the read/write operation, can reduce the occupying ratio of the servo control process when a disk rotates at high speed, and can secure sufficient head positioning accuracy when necessary in the disk drive having the function for changing the rate of rotation of a disk.

### Second Embodiment

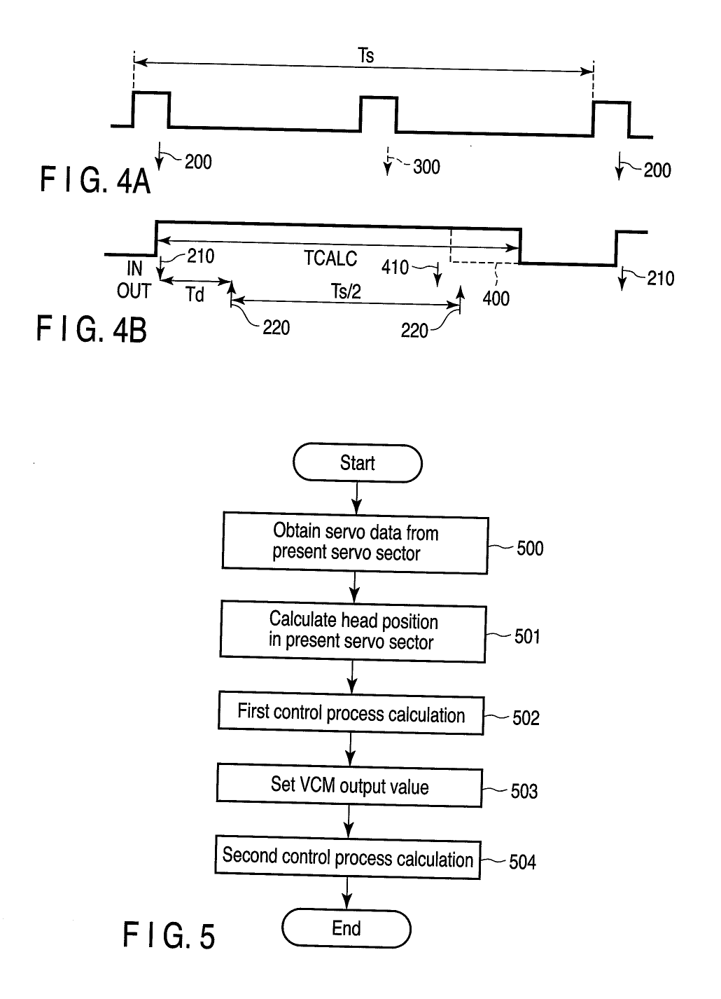

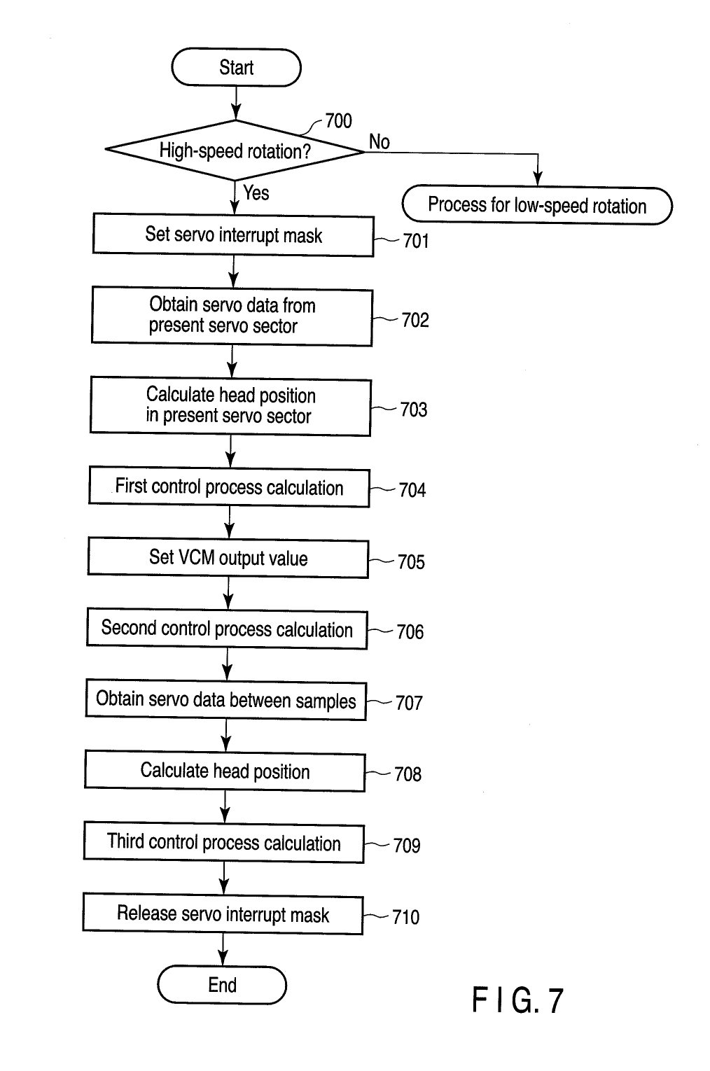

Timing charts of FIGS. 4A and 4B a flowchart of FIG. 7 are views explaining a servo control operation according to a second embodiment. Note that since the configuration of the disk drive is same as that shown in FIG. 1, it will be explained referring to FIG. 1.

The embodiment is configured such that a Multiple Input Multiple Output (MIMO) control calculation, which is composed of first to third control process calculations, is executed when a high-speed rotation mode different from the first embodiment is set.

A specification of the disk drive of the second embodiment is basically the same as that of the first embodiment, and the CPU 21 has the same operation clock in either high- or low-speed rotation mode. However, high- and low-speed rotation modes have a rotational speed ratio of, for example, about 1.71.

The embodiment is configured such that even if a large disturbance force called a wind turbulence acts in a positioning operation of a head 12 in high-speed rotation mode, a required head positioning accuracy can be achieved. That is, in the Single Input Multiple Output (SIMO) control calculation method shown in the first embodiment, when the disturbance force acts, it is difficult to achieve the required head positioning accuracy only by adjusting control parameters in a control cycle in which a servo is thinned out. Thus, in the embodiment, sufficient head positioning accuracy is realized in a control cycle in which a servo is thinned out in high-speed rotation mode by employing the MIMO control calculation method to be described later.

The servo control operation of the embodiment will be explained below referring to a flowchart of FIG. 7.

In the disk drive, when a request for switching to high-speed rotation mode is issued from a host system 3, a CPU 21 retracts once the head 12 on a disk 10 outside of the disk 10 and sets a flag for high-speed rotation mode in a memory 31. The CPU 21 selects an MIMO-type control calculation method to be described later in high-speed rotation mode based on the flag and executes a servo control of a feed back control process different from that for low-speed rotation mode.

Further, in the embodiment, a control configuration is employed in which control parameters are embedded as fixed number codes that are different in two control calculation methods in place of control parameters set to variables in a servo control process. Further, since a signal passing-through frequency of servo sectors also increases in proportion to the rotational speed, setting and the like of a clock frequency (F_{sfg}) for detecting servo data in a read/write channel 20 are also switched. Gate timing of servo gates and the like is generated at approximately the same passing-through timing to the disk 10 by the switching of a clock. At the same time, the CPU 21 executes a rotational speed change process of an SPM 11 and executes a positioning control by moving the head 12 to a track position on the disk 10 before it is retracted after the rotation of the SPM 11 is adjusted and fixed. Further, the CPU 21 controls the head 12 so that the slider thereof is set to an optimum floating height in high-speed rotation mode by the dynamic floating height (DFH) control function described above.

Next, a procedure of the servo control process executed by the CPU 21 in high-speed rotation mode will be explained.

When a servo interrupt is issued from an interrupt controller 23, the CPU 21 confirms whether or not the flag for high-speed rotation mode is set in the memory 31 (block 700). The CPU 21 executes an ordinary servo control process in low-speed rotation mode (block 700: NO).

The CPU 21 executes a servo interrupt mask process in high-speed rotation mode (block 701). Specifically, the CPU 21 changes setting of an interrupt mask register of the interrupt controller 23, which outputs a servo interrupt request to the CPU 21, according to the control of an HDC 22. That is, the CPU 21 prevents the servo interrupt request from being output to the CPU 21 when the head 12 passes through the servo sectors on the disk 10. With this process, it can be prevented that a next servo interrupt request is issued while the servo control process is being executed by the CPU 21.

As shown in FIG. 4A, the HDC 22 outputs servo gates of a frequency T_{svg} to the read/write channel 20 at timing at which the servo sectors of the rotating disk 10 pass just below the head 12 likewise the first embodiment described above. The HDC 22 obtains the servo data reproduced by the read/write channel 20 according to the timing of the servo gates and stores it to a register 30 (block 702).

As shown in FIG. 4B, the HDC 22 issues a servo interrupt request 200 to the CPU 21 through the interrupt controller 23. At the time, the interrupt controller 23 does not output a servo interrupt request 300 to the CPU 21 according to the timing of a next servo gate in response to setting of the interrupt mask register.

The CPU 21 reads the servo data from the register 30 of the HDC 22 in response to the interrupt request 200 and stores it to the memory 31. The CPU 21 calculates position information (servo information) for determining a present head position on the disk 10 using the servo data (block 703).

Thereafter, when the flag for high-speed rotation mode is set, the CPU 21 executes an MIMO-type control process calculation which is different from that for low-speed rotation mode as a control process calculation for positioning the head 12 to a request position (blocks 704 to 709). The MIMO-type control process calculation is a calculation method of two inputs (210, 410) and two outputs (220) for creating two VCM output values of a present servo sector and a servo sector to be thinned-out next time using two pieces of position information of the present servo sector and a servo sector thinned out just before as inputs.

Note that although the MIMO control calculation system, which calculates an output by the two inputs/two outputs process, is employed in the embodiment, an MISO (Multi Input Single Output) control calculation system of two inputs and one output may be employed.

That is, the CPU 21 calculates and creates two VCM output values, that is, a VCM output value 220 corresponding to the present servo sector and a VCM output value 220 corresponding to the servo sector which is to be thinned out next time by an interrupt 300 for stopping an output by executing the MIMO control process calculation which basically takes an input/output delay time Td into consideration. The MIMO-type control process calculation is composed of three steps of first to third control process calculations. The first control process calculation executes only a control calculation which is difficult unless the position information obtained from the present servo sector is used (block 704).

The CPU 21 sets the calculated VCM output values 220 to a control output register of the HDC 22 (block 705). After the VCM output values are set, the CPU 21 executes the second control process calculation described above at a second time (block 706). In the second control process calculation, a feed forward control command amount, which can be calculated previously, is calculated, and the portions that can be calculated such as determination of a mode and an MIMO control calculation are preprocessed to calculate a next VCM output value.

In the embodiment, since a control process, which is the same as that in low-speed rotation mode, is applied to the servo control processes other than the MIMO control calculation, the portions which are separated by the flag for high-speed rotation mode are subjected to only the preprocess of the MIMO control calculation and thereafter subjected to a common calculation.

Further, to prepare for a next MIMO control calculation, the CPU 21 reads the servo data of servo sectors whose servo calculation is thinned out in the calculation from the register 30 of the HDC 22 and stores it to the memory 31 (block 707). That is, the HDC 22 also stores the servo data of the servo sectors to be thinned out to the register 30. The CPU 21 inputs the servo data at timing 410 shown in FIG. 4B and calculates the position information (servo information) for determining a head position on the disk 10 (block 708).

Next, the CPU 21 executes the third control process calculation included in the MIMO control process calculation using the calculated position information (block 709). The CPU 21 sets the calculated VCM output values 220 to the control output register of the HDC 22. The CPU 21 releases a servo interrupt mask set by the interrupt mask register of the interrupt controller 23 and returns it to an original state just before it finishes the servo control process (block 710). With this operation, when the head 12 passes through the servo sectors on the disk 10, the servo interrupt request 200 is generated again. Note that the servo interrupt mask need not be necessarily released just before the servo control process is finished and may be released at any time before an arbitrary period of time passes from the finish of the servo control process.

As described above, according to the embodiment, since the servo control process is executed by the MIMO-type control calculation method in high-speed rotation mode, the control calculation can be executed using the position information corresponding to the servo sectors to be thinned out when the third control process calculation is executed. Since the servo control process can execute the head positioning control between sample points making effectively use of the servo data obtained from the thinning-out servo sectors in comparison with the method of the first embodiment, a head position determination accuracy can be greatly improved.

In particular, even a control frequency, which is greatly affected by a disturbance caused by high-speed rotation of the disk 10 and corresponds to a thinning-out servo, can achieve a necessary head positioning accuracy. Accordingly, the disk drive having the plurality of disk rotational speed modes can realize a stable control operation as well as secure the necessary head positioning accuracy by reducing the control cycle by thinning out the servo sectors even in a rotating operation mode by which the rotational speed is greatly changed.

A sampling frequency is not greatly changed in high-speed rotation mode, which is advantageous in that a control design can be easily made. Further, since the head positioning accuracy can be improved in high-speed rotation by employing the MIMO control calculation method, the disk drive can be provided which has the plurality of disk rotational speed modes to which a considerably high rate of rotation is set as high-speed rotation mode.

Note that, in the embodiment, a calculation amount is increased by employing the MIMO control calculation method although an operation clock of the CPU 21 is fixed. That is, as shown in FIG. 4B, the calculation time T_{CALC} Of the CPU 21 is more increased than that of low-speed rotation mode. Further, the input/output delay time Td is also increased compared with that for low-speed rotation mode.

When the control calculation time T_{CALC} of the CPU 21 increases in a large amount, the control calculation time and the control cycle Ts are made to approximately the same time. However, since a portion having a large calculation load is a process of a feed forward control calculation and the like such as RRO suppressing compensation and the like, an increase of a calculation load applied by the MIMO control process is small. Therefore, a relation of “Tₛ>T_{CALC}” can be realized with a sufficient margin.

In short, when the MIMO control calculation method of the embodiment is employed, since the servo data of the thinned-out servo sectors can be used, the head positioning accuracy can be greatly improved as compared with the SIMO control calculation method which simply employs the thinning-out servo. As described above, the servo data of the thinned-out the servo sectors can be obtained at input timing 410 shown in FIG. 4B. Since the HDC 22 opens the servo gates to the servo sectors to be thinned out, the servo data read from the servo sectors is obtained and stored to the register 30.

That is, at the input timing 410 shown in FIG. 4B, even if the head 12 passes through the thinning-out servo sectors, the HDC 22 obtains the servo data from the read/write channel 20 and already sets it to the register 30. Accordingly, the servo data of the thinning-out servo sectors, which is intrinsically a future value, is obtained from an initial servo interrupt 200 and can be used by the third control process calculation.

Further, in the embodiment, a calculation, which uses the position information of the servo sectors to be thinned out, is executed as a preprocess of a next control process in the third control process calculation so that the input/output delay time Td is minimized. However, since the third control process calculation does not have a too large calculation load, the third control process calculation may not be executed by including it in the first control process calculation.

Further, in the embodiment, although the MIMO control calculation is applied to either a tracking control or a seek control, the SIMO control calculation may be executed in the seek control. This is because the MIMO control calculation method is effective as a countermeasure for overcoming an insufficient head positioning accuracy in the tracking control. As to the seek control, it is predicted that no problem arises even if a simple thinning-out servo method is employed. Note that although it is disadvantageous that the input/output delay time changes when the seek control and the tracking control are switched, since switching them is advantageous in that a calculation load is small and a seek adjustment can be easily performed, the SIMO control calculation method is effective in the seek control.

### Other Embodiment

As a field to which the first and second embodiments are applied, there is an inspection process before products are shipped in a manufacturing process of the disk drive. In the inspection process, a step is necessary to detect a defective drive by rotating the disk 10 assembled in the disk drive at a rate of rotation greater than that prescribed by the specification. Inspection time can be reduced by rotating the disk at a high rate of rotation. In this case, the servo control of the head 12 can be securely executed at high speed by executing the servo control process in high-speed rotation mode in the first and second embodiments. Accordingly, the first and second embodiments can be effectively applied not only to the disk drive as a product but also to the inspection process before the product is shipped in which reduction of an inspection time is particularly required in the manufacturing process of the disk drive.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head configured to write and read data;
a disk configured to hold data written by the head, the disk comprising a plurality of the servo sectors to which servo data is recorded and the plurality of the servo sectors is disposed at predetermined intervals in a circumferential direction;
a spindle motor configured to rotate the disk;
a speed changer configured to drive control the spindle motor and to increase and decrease a rate of rotation of the disk;
an actuator configured to position the head at a target position on the disk;
a servo data reproduction module configured to reproduce servo data read from the servo sectors on the disk by the head and to store the servo data to a memory; and
a servo controller configured to execute a servo control operation in order to cause the actuator to position the head,
wherein the servo controller is configured to subtract acquisition of servo data of a first servo sector in the servo data corresponding to the servo sectors and to execute the servo control operation once per two servo sectors.

2. The disk drive of claim 1, further comprising:
an interrupt controller configured to output an interrupt request of the servo control to the servo controller,
wherein the interrupt controller is configured to intermittently restrict the output of the interrupt request when the rotational speed of the disk is increased.

3. The disk drive of claim 2, wherein
the servo data reproduction module comprises a disk controller configured to create servo gate signals indicative of timing when servo data is read from the servo sectors by the head and to store the reproduced servo data to the memory based on the servo gate signals,
wherein the interrupt controller is configured to output the interrupt request of the servo controlling to the servo controller in response to controlling of the disk controller.

4. The disk drive of claim 2, wherein the servo controller is configured to set an interrupt mask to the interrupt controller in order to prevent the interrupt controller from issuing a next interrupt request after the interrupt request is received from the interrupt controller and to release the interrupt mask before completing the servo controlling corresponding to the interrupt request, in a state that the rotational speed of the disk is increased by the speed changer.

5. The disk drive of claim 4, wherein the servo controller is configured to calculate a multi-rate output in order to calculate a control output value for controlling the drive of the actuator at a predetermined servo control cycle, to start the servo control operation in response to the input of the interrupt request from the interrupt controller, to set the interrupt mask to the interrupt controller, and to release the interrupt mask in a period until the servo controlling in response to the interrupt request is completed.

6. The disk drive of claim 1, wherein the speed changer comprises a memory configured to store flag information indicative of either a high-speed rotation mode for increasing the rotational speed of the disk or a low-speed rotation mode for decreasing the rotational speed of the disk in response to an external command.

7. The disk drive of claim 6, wherein the servo controller is configured to execute a first servo control operation comprising the subtracting when high-speed rotation mode is set and to execute a second servo control operation without the subtracting when low-speed rotation mode is set based on the flag information.

8. A disk drive comprising:
a head configured to write and read data;
a disk configured to hold the data written by the head, the disk comprising a plurality of the servo sectors to which servo data is recorded and the plurality of the servo sectors is disposed at predetermined intervals in a circumferential direction;
a spindle motor configured to rotate the disk;
a speed changer configured to control driving of the spindle motor and to increase and decrease the rate of rotation of the disk;
an actuator configured to position the head at a target position on the disk;
a servo data reproduction module configured to reproduce servo data read from the servo sectors on the disk by the head and to store the servo data to a memory;
an interrupt controller configured to output an interrupt request of a servo control for controlling the actuator;
an interrupt masking module for setting an interrupt mask to the interrupt controller in order to prevent the interrupt controller from issuing a next interrupt request after an interrupt request is received from the interrupt controller in a state that the rotational speed of the disk is increased by the speed changer; and
a servo controller configured to execute a servo control operation in order to calculate a control output value for controlling the actuator using the servo data read from the memory in response to the interrupt request,
wherein the servo controller is configured to calculate the control output value using first servo data obtained from the memory in the servo control operation when a previous interrupt request was issued and second servo data obtained from the memory when a current interrupt request is issued, and
the servo controller is configured to obtain servo data reproduced from a servo sector corresponding to an interrupt request prevented by the setting of the interrupt mask after a period for reproducing servo data of one servo sector and to calculate for a next interrupt request in advance.

9. The disk drive of claim 8, wherein
the servo controller is configured to calculate a two input two output control in order to calculate a first control output value and a second control output value as the control output values using the first servo data and the second servo data, and
the servo controller is configured to output the second control output value after a period for reproducing servo data of about one servo sector after the first control output value is output for controlling the actuator.

10. The disk drive of claim 8, wherein the speed changer comprises a memory for storing flag information indicative of either a high-speed rotation mode for increasing the rotational speed of the disk or a low-speed rotation mode for decreasing the rotational speed of the disk in response to an external command.

11. The disk drive of claim 10, wherein the servo controller is configured to calculate the control output value or the two input and two output control when high-speed rotation mode is set based on the flag information.

12. A servo control method for a disk drive comprising a head and a disk, the method comprising:
switching the rotational speed of the disk to either a high-speed rotation mode for increasing the rotational speed or a low-speed rotation mode for decreasing the rotational speed in response to an external command;
reproducing servo data read from the servo sectors on the disk by the head and storing the servo data to a memory; and
servo controlling once per two servo sectors using the servo data obtained from the memory and subtracting acquisition of the servo data of one servo sector in the servo data corresponding to the servo sectors in a state where the rotational speed of the disk is increased.

13. The method of claim 12, further comprising intermittently restricting an output of the interrupt request when the rotational speed of the disk is increased and an interrupt request of the servo control is sent.

14. A servo control method for a disk drive comprising a head and a disk, the method comprising:
switching the rotational speed of the disk to either a high-speed rotation mode for increasing the rotational speed and a low-speed rotation mode for decreasing the rotational speed in response to an external command;
reproducing servo data read from the servo sectors on the disk by the head and storing the servo data to a memory;
setting an interrupt mask in order to prevent an interrupt controller issuing a next interrupt request after an interrupt request of a servo control is received in a state that the rotational speed of the disk is increased; and
calculating the control output value using first servo data obtained from the memory and second servo data obtained from the memory at the time a current interrupt request is issued when the servo is controlled using servo data read from the memory in response to the current interrupt request.

15. The method of claim 14, further comprising obtaining servo data reproduced from a servo sector corresponding to an interrupt request prevented by setting of the interrupt mask after a period for reproducing servo data of one servo sector and calculating for a next interrupt request.
